(19) United States
(12) Patent Application Publication
(10) Pub. No.: US 2016/0267537 A1
(43) Pub. Date: Sep. 15, 2016

(54) Social Commerce Affiliate Exchange

(71) Applicant: PayPal, Inc., San Jose, CA (US)

(72) Inventor: William Henry Runyan, San Jose, CA (US)

(21) Appl. No.: 14/645,665

(22) Filed: Mar. 12, 2015

(51) Int. Cl. G06Q 30/02; G06Q 50/00

(52) U.S. Cl. CPC G06Q 30/0261; G06Q 50/01

(57) ABSTRACT

Methods, systems, and computer program products for providing a social commerce affiliate exchange are disclosed. A computer-implemented method may include creating an affiliate program account for a user, registering a product with the affiliate program account, adjusting a privacy setting associated with the registered product in the affiliate program account, associating the registered product with a profile in the affiliate program account, associating the registered product with a provider of the product, providing information about the registered product to a beacon device, sending a beacon message with information about the registered product to a computing device of another user, detecting an activity performed by the second user associated with the beacon message, adjusting a reputation score for the user in view of the activity performed by the second user, and crediting the affiliate program account of the user in view of the activity performed by the second user.

### TECHNICAL FIELD

The present disclosure generally relates to computer systems and, more particularly, to providing social commerce affiliate exchange services using specialized beacon devices, the Internet, and user interfaces.

### BACKGROUND

Consumers encounter many individuals throughout out their respective daily routines. For example, consumers come in contact with others when in transit, at school, at work, at the library, at the coffee shop, at the grocery store, at the mall, at sporting events, and in other various locations. During these interactions, consumers observe and notice the appearance, behavior, and products of others. As such, consumers have the ability to influence a wide audience based on their everyday appearance and activities.

For example, a consumer may see a clothing item, electronic device, bag, or other item used by another person in public. Based on the observation, the consumer may wish to purchase an item for themself or for someone else. However, the consumer may not recognize or know where to buy the item. In addition, the consumer may not have an opportunity or desire to ask the other person about the name, brand, size, price, or seller of the item. Further, even if the consumer eventually is able to identify and locate the item, a person who generates consumer interest through their daily use of goods and services is not rewarded. Therefore, new and improved ways of sharing product information among users and compensating users who generate interest and sales from their use of products are of importance.

### BRIEF DESCRIPTION OF THE DRAWINGS

Various examples of the present disclosure will be understood more fully from the detailed description given below and from the accompanying drawings of various examples of the disclosure. In the drawings, like reference numbers may indicate identical or functionally similar elements. The drawing in which an element first appears is generally indicated by the left-most digit in the corresponding reference number.

FIG. 1 is a block diagram illustrating a system architecture, in accordance with various examples of the present disclosure.

FIG. 2 is a flow diagram for providing a social commerce affiliate exchange, according to an example of the present disclosure.

FIG. 3 is a flow diagram for providing a social commerce affiliate exchange with reputation scoring, according to an example of the present disclosure.

FIG. 4 is a flow diagram for processing social commerce affiliate exchange messages, according to an example of the present disclosure.

FIG. 5 is a flow diagram for providing social commerce affiliate exchange reporting, according to an example of the present disclosure.

FIG. 6 is a block diagram of an exemplary computer system that may perform one or more of the operations described herein.

### DETAILED DESCRIPTION

Systems, methods, and computer program products are disclosed for providing a social commerce affiliate exchange. In an example, a social commerce affiliate exchange allows individual consumers to share information about various products (i.e., goods and services) directly with other nearby users. Users then may discover and browse the shared product information to learn more about products, to find providers of products, or to complete online product purchases. Consumers who share product information with others are rewarded for introducing products to others, assisting others in identifying products, and helping to promote products and product providers.

In an example, a consumer creates an affiliate program account that allows the consumer to participate in a social commerce affiliate exchange. The consumer registers one or more products (i.e., goods and services) in an inventory of products associated with the affiliate program account. The consumer then may adjust privacy settings for the registered products to indicate conditions when respective product information should be shared with other users. The consumer then may associate the registered products with one or more profiles that indicate situations when various products should be shared with others (e.g., home, work, gym). The consumer also may associate registered products with one or more providers so that other users are introduced or redirected to corresponding product providers when viewing shared product information.

In an example, a consumer selects one or more items from their affiliate program account providing to provide to a beacon device. For example, a consumer may select several items in an outfit they are wearing from a product inventory to be provided to a beacon device. The beacon device receives the product selections and associated product information to be shared with other users. The beacon device then transmits beacon messages with information about the shared products to computing devices within range of the beacon device. A user receiving the beacon message may read and learn more about the items comprising the consumer's outfit, which the consumer chose to share with others.

In an example, the consumer may be rewarded based on activity of other users who view or purchase one or more items based on the shared product information in the beacon message. For example, the consumer may receive compensation or a commission for helping others to discover, find, and purchase products of interest. Further, a reputation score for the consumer also may increase in response to such events.

Accordingly, aspects of the present disclosure provide users with the ability to discover, browse, learn about, and purchase goods and services based on shared information provided by other nearby individuals. Further, users who share product information with others are rewarded for driving promotion and sales of both products and product providers.

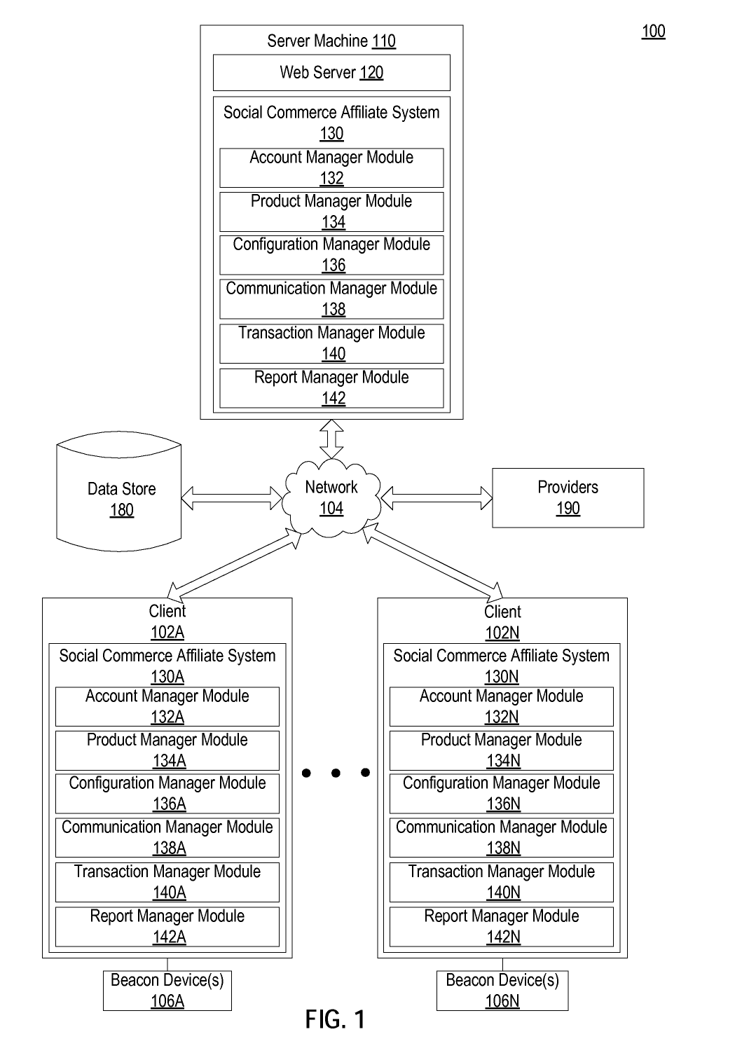

FIG. 1 illustrates an exemplary system architecture 100 in which examples of the present disclosure may be implemented. System architecture 100 includes one or more server machines 110, one or more data stores 180, one or more client machines 102A-102N, and one or more providers 190 connected via one or more networks 104.

Network 104 may be a public network (e.g., the Internet), a private network (e.g., local area network (LAN) or wide area network (WAN)), or any combination thereof. In an example, network 104 may include the Internet, one or more intranets, wired networks, wireless networks, and/or other appropriate types of communication networks. In one example, network 104 may comprise a wireless telecommunications network (e.g., cellular phone network) adapted to communicate with other communication networks, such as the Internet. Network 104 also may include one or more short-range wireless networks or beacon networks.

Data store 180 refers to persistent storage capable of storing various types of data, such as text, audio, video, and image content. In some examples, data store 180 may include a network-attached file server, while in other examples data store 180 may include other forms of persistent storage such as an object-oriented database, a relational database, and so forth.

Client machine 102A may be a personal computer (PC), laptop, mobile phone, tablet computer, server computer, wearable computing device, or any other type of computing device. Client machine 102A may run an operating system (OS) that manages hardware and software of the client machine 102A. A browser (not shown) may run on the client machines (e.g., on the OS of the client machines). The browser may be a web browser that can access content and services provided by web server 120 of server machine 110. Other types of computer programs and computer scripts also may run on client machine 102A.

Client machines 102A-102N each may include one or more respective beacon device(s) 106A-106N, and a respective social commerce affiliate system 130A-130N. Social commerce affiliate systems 130A-130N each include a respective account manager module 132A-132N, product manager module 134A-134N, configuration manager module 136A-136N, communication manager module 138A-138N, transaction manager module 140A-140N, and report manager module 142A-142N. In various examples, such modules may be combined, divided, and organized in various arrangements on one or more computing devices.

In an example, client machine 102A is coupled to one or more beacon devices 106A. A beacon device 106A generally refers to a short-range communication device having a known or fixed location. In general, beacon device 106A usually provides a signal or beacon message that can be detected and read by other computing devices within a certain proximity of the beacon device 106A. Various types of beacon devices 106A may include, but are not limited to, radio frequency (RF) beacon devices 106A (e.g., Bluetooth™ low energy (BLE) beacons), infrared beacon devices 106A, radio frequency identifier (RFID) tags, computing devices that emit signals or beacon messages (e.g., mobile computing devices, mobile telephones, wearable computing devices, etc.).

In an example, a BLE beacon device 106A may broadcast an RF signal that includes position coordinates (e.g., latitude, longitude, altitude), product information, or any other information, which then can be received and read by another computing device. In some examples, beacon device 106A may advertise location-based services, product information, or any other information using a beacon network comprised of a plurality of associated beacon devices.

Providers 190 generally refer to one or more parties that make, sell, distribute, market, or are otherwise involved in the creation or provisioning of a product. Providers 190 generally may include, but are not limited to, manufacturers, distributors, wholesalers, retailers, merchants, payment processors, marketers, or any other type of person or entity interested in the promotion or sale of a product. Products generally refer to goods and/or services that are offered for sale or consumption. Thus, products may include clothes, jewelry, accessories, shoes, beauty products, beauty services, automobiles, automobile services, health services, food, nutrition services, gym memberships, personal trainer services, etc.

Server machine 110 may include one or more web server 120. Web server 120 may provide text, audio, image, and video content from server machine 110 or other sources (e.g., data store 180) to client machines 102A-102N. Web server 120 also may provide web-based application services, business logic, and updates to client machines 102A-102N. Client machines 102A-102N may locate, access, and consume various forms of content and services from web server 120 using applications, such as a web browser, web servers, application servers, computer programs, etc. Web server 120 also may receive text, audio, video, and image content from client machines 102A-102N, which may be stored in data store 180 for preservation and/or sharing of content.

In an example, web server 120 is coupled to one or more application servers (not shown) that provide application services, data, and/or APIs to client machines 102A-102N. In one example, web server 120 may provide client machines 102A-102N with access to one or more application services associated with a social commerce affiliate system 130. Such functionality also may be provided, for example, as part of one or more different web applications, standalone applications, system, plug-ins, web browser extensions, and application programming interfaces (APIs). In some examples, plug-ins and extensions also may be referred to, individually or collectively, as “add-ons.”

In an example, client machines 102A-102N may include an application associated with a service provided by server machine 110 (e.g., social commerce affiliate system 130). For example, various types of computing devices (e.g., smart phones, smart televisions, tablet computers, smart wearable devices, smart home computer systems, etc.) may use applications to access services provided by server machine 110, to issue commands to server machine 110, and/or to receive content from server machine 110 without visiting or using web pages.

In an example, functions performed by server machine 110 and/or web server 120 also may be performed by the client machines 102A-102N, in whole or in part. In addition, the functionality attributed to a particular component may be performed by different or multiple components operating together. Further, server machine 110 may be accessed as a service provided to other systems or devices via appropriate application programming interfaces (APIs), and thus is not limited to use with websites.

For example, client machines 102A-102N each may include respective social commerce affiliate systems 130A-130N and/or one or more client modules of a respective social commerce affiliate system 130A-130N for providing social commerce affiliate exchange services to a user. Further, server machine 110 may include a respective social commerce affiliate system 130 and/or one or more server-based modules of a social commerce affiliate system 130.

In an example, an account manager module 132 of a social commerce affiliate system 130 creates, updates, and maintains user accounts associated with an affiliate program. For example, account manager module 132 may receive requests from users seeking to participate in a social commerce affiliate exchange. In response to such requests, account manager module 132 may create respective user accounts to allow new users to participate in the social commerce affiliate exchange.

In an example, account manager module 132 registers and/or associates an existing third-party user account (e.g., social media account, external e-mail account, etc.) with a social commerce affiliate exchange to allow the user to participate in the exchange. In some examples, account manager module 132 also may update and remove existing user accounts based on corresponding user requests.

In an example, a social commerce affiliate exchange generally describes a service that allows users to promote products (e.g., goods and/or services) independently and directly to other nearby users using beacon devices 106A. For example, a user participating in a social commerce affiliate exchange may share information about various products with others using a beacon device and receive credit in response to influencing the actions of others with respect to a product. For example, a user may introduce other users to a product. A user also may influence other users to learn more about product, save a product for later consideration, and ultimately to purchase or use a product. Further, a social commerce affiliate exchange also may allow a user to communicate and partner with one or more providers 190 interested in promoting various products, for example, based on the user's ability to influence others.

In an example, a product manager module 134 of a social commerce affiliate system 130 allows a user to manage various product inventory associated with a user's social commerce affiliate program account. For example, product manager module 134 may associate new products with a user account, modify existing products already associated with the user account, or remove products from a user account.

In an example, product manager module 134 receives a request to associate a product with a user's social commerce affiliate program account. For example, a user may request to register or add a product to an account by entering a unique product identifier, providing descriptive information about product, or providing a link or URL the product. In some examples, a user may manually enter product codes and information. A user also may scan text, numerals, barcodes, QR codes, or other information that product manager module 134 uses to identify and associate a product with the user's account. Further, a user also may provide a photo or other image that product manager module 134 uses to identify and associate a product with the user's account. In general, various products (i.e., goods or services) associated with a user account may be owned, used, promoted, or otherwise associated with a respective user.

In an example, a configuration manager module 136 of a social commerce affiliate system 130 performs configuration related tasks involving products registered with an affiliate program account. In one example, configuration manager module 136 adjusts a privacy setting associated with a product in a user's account. For example, a user may indicate that the user's association, endorsement, affiliation, or use of a product is to be transmitted publicly, via a beacon device, to any other user within range of the beacon device. A user also may indicate a preselected group of one or more individuals (e.g., friends, family, coworkers, classmates, consumers, various demographic categories, etc.) are to receive information about a product associated with the user's account from a beacon device. Therefore, a user may choose to promote various products associated with the user's account using a beacon device based on a level of privacy that the user wishes to maintain with respect to each product or a grouping of products. For example, a user may choose to promote expensive, concealed, private, or other types of products on a selective basis to one or more other identified users or user groups with privacy settings.

In an example, configuration manager module 136 associates a product registered in an affiliate program account with one or more account profiles. In one example, a user creates one or more account profiles based on activities, locations, or other criteria. For example, a user may have a general or default profile. A user also may define other various profiles such as visiting friends, visiting relatives, hosting friends, hosting relatives, home, school, work, gym, shopping, dining out, commuting, driving, swimming, hiking, a neighborhood, a city, a region, a country, etc. The user then may associate products registered in their account with various profiles indicating that the user wishes to share information about such products when corresponding profiles are selected or active. For example, a user may wish to promote wearable athletic gear using beacon device 106A when the user is running or at the gym, but not when the user is operating a vehicle or performing a non-athletic activity.

In an example, configuration manager module 136 associates a product registered in an affiliate account with provider 190 to allow a user promoting a product via beacon device 106A to refer and/or direct other users to a user-selected provider 190 of the product. In one example, configuration manager module 136 associates a product with provider 190 so that a beacon message sent to other users refers the users to the associated provider 190. For example, configuration manager module 136 may configure a product link or URL in a beacon message to direct other users to a preselected product provider 190.

In an example, configuration manager module 136 provides information about a product in an affiliate program account to beacon device 106A. For example, configuration manager module 136 may send or write information about one or more products associated with the user's account to a beacon device 106A that is to send beacon messages comprising the product information to other users. For example, configuration manager module 136 may write or send product information to a beacon device 106A that is to be shared or transmitted to one or more other in-range client machines 102N using beacon messages. In an example, beacon device 106A may be integrated into a product by provider 190 (e.g., sewn into clothing), manually attached or coupled to a product by a user (e.g., placed or secured on clothing or in a vehicle), carried by a user, or integrated in a user's computing device (e.g., client machine 102A). Thus, a user may utilize one or more different beacon devices 106A to promote various associated products. Further, beacon device 106A may be separate from client machine 102A (e.g., an RFID tag) or integrated into client machine 102A (e.g., a wireless communication device).

In an example, a communication manager module 138 of a social commerce affiliate system 130 sends one or more beacon messages comprising information about products associated with a user account to respective computing devices of other users. In one example, a communication manager module 138A of client machine 102A or associated beacon device 106A wirelessly transmits beacon messages comprising information about one or more products directly to computing devices of other users within communication range. Such product information may include one or more respective links or URLs to associated providers 190 that a user has identified for each product. Further, in some examples, product information may be sent by communication manager module 138 according to privacy settings and/or profile settings indicated by a user. Thus, each beacon messages may be tailored to a particular recipient user or audience and/or may be based on a detected or user-selected profile setting.

In an example, one or more computing devices of other respective users (e.g., client machines 102N) may receive a beacon message comprising product information directly from one or more in-range beacon devices 106A. A user receiving one or more beacon messages may browse a list of current, recent, or past beacon messages, display information associated with a beacon message, query one or more beacon messages, create alert notifications for beacon messages matching one or more predefined criteria, receive alert notifications for beacon messages, store beacon messages for later reference, etc.

In an example, a transaction manager module 140 of a social commerce affiliate system 130 detects when a user receiving a beacon message performs an activity based on the beacon message. For example, a transaction manager module 140N on a client machine 102N that has received a beacon message may detect that a recipient user browses the beacon message individually or as part of a list, displays or views beacon message information, selects a product described in the beacon message for display, views a product described in the beacon message for a period of time, saves a product in the beacon message for later review, adds a product in the beacon message to a wishlist, adds a product in the beacon message to a shopping cart, purchases a product in the beacon message either generally or from an associated provider 190, shares a product in the beacon message with others, or recommends a product in the beacon message. In one example, such client activity involving a beacon message and associated products may be communicated to transaction manager 140 on server machine 110, for example, to allow computation of reputation scores and/or credit to be provided to referring affiliate program user accounts.

In an example, transaction manager 140 computes and adjusts a reputation score for a user account based on activities performed by other users in response to beacon messages from the user. In general, a reputation score may indicate a user's ability to influence the decision making, interests, or behavior of others. Further, transaction manager 140 may credit an affiliate program account of a user in view of an activity associated with a beacon message or referenced product that is performed by another user.

For example, transaction manager 140 may provide a monetary credit to the account of a user when another user purchases a product based on a beacon message from the user. In some examples, transaction manager 140 debits an account of a provider 190 receiving a referral based on a beacon message. Further, transaction manager 140 also may transfer credit from a provider 190 account to a user account when a user provides a provider 190 referral or associated product sale via a beacon message.

In an example, a report manager module 142 of a social commerce affiliate system 130 generates a report of affiliate program users based on a reputation score computed for each user. For example, report manager module 142 may generate and display a reputation score report indicating each user's ability to promote one or more products. In some examples, various types of reputation score reports may include users who are trending based on product referrals, users with the most beacon message views, users who have referred the most sales using beacon messages, users who have been liked the most by others, recently added users, etc.

In some examples, report manager module 142 generates a report of affiliate program users for provider 190. The provider 190 may select and send one or more of the users an offer to promote the provider 190 and/or associated products for a commission. A user then receives the offer from the provider 190, which the user may accept or reject. The user then submits a response to the offer. The user's response is received and communicated to the requesting provider 190. Agreed upon terms between a user and provider 190 can be used in the management of transactions and when compensating a user based on promotion of the provider 190 and/or associated products.

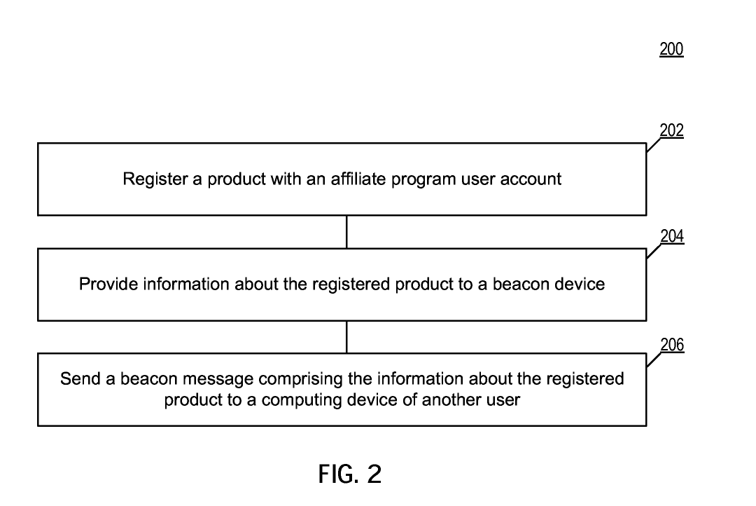

FIG. 2 is a flow diagram for providing a social commerce affiliate exchange, according to an example of the present disclosure. The method 200 may be performed by processing logic that may comprise hardware (circuitry, dedicated logic, programmable logic, microcode, etc.), software (such as instructions run on a general purpose computer system, dedicated machine, or processing device), firmware, or a combination thereof. Examples in the method 200 are described with respect to social commerce affiliate system 130A for the sake of consistency. Such examples also generally apply to various other social commerce affiliate system 130, 130N examples described herein.

Method 200 begins at block 202 when product manager module 134A of social commerce affiliate system 130A registers a product with an affiliate program user account. In an example, product manager module 134A associates a product (i.e., a good or service) with an affiliate program account. For example, product manager module 134A may add a product to a user account based on a unique product identifier, a descriptive product identifier, information or details about the product, a link or URL, barcodes, QR codes, photos, images, and/or other input provided by a user.

At block 204, configuration manager module 136A of social commerce affiliate system 130A provides information about the registered product to a beacon device 106A. In an example, configuration manager module 136A sends or writes information about one or more products to a beacon device 106A. For example, configuration manager module 136A may send or write product information directly to a beacon device 106A that is external from client machine 102A (e.g., an RFID tag, iBeacon, etc.). Configuration manager module 136A also may provide product information to a beacon device 106A that is local to client machine 102A (e.g., a wireless communication device).

In an example, configuration manager module 136A provides beacon device 106A with product information. Beacon device 106A then wirelessly transmits the product information to other client machines 102N within communication range of the beacon device 106A. In one example, configuration manager module 136A also provides beacon device 106A with associated product configuration information based on one or more affiliate program account settings. For example, configuration manager module 136A may provide product information to beacon device 106A that includes privacy settings indicated for respective products in an account, one or more user profiles indicated for respective products in the user account, and one or more providers indicated for respective products in the user account. In some examples, beacon device 106A may use such product configuration information to create and distribute associated beacon messages selectively to other client machines 102N in accordance with user preferences.

In an example, configuration manager module 136A provides updated product information to beacon device 106A. For example, a user first may associate one or more pieces of clothing and/or other products with beacon device 106 for a particular day or occasion. The user then may reconfigure or refresh beacon device 106A with new or updated product information for a different day or occasion. In one example, configuration manager module 136A allows a user to modify which products a user is to promote using beacon device 106A by providing updated product information to the beacon device 106A in response to user updates. Thus, configuration manager module 136A may configure beacon device 106A for a user each day or one or more times throughout each day for a user.

At block 206, communication manager module 138A of a social commerce affiliate system 130A sends a beacon message comprising the information about the registered product to a computing device of another user. In an example, a communication manager 138A of a client machine 102A or associated beacon device 106A wirelessly transmits one or more beacon messages comprising product information provided by configuration manager 136A directly to in-range client machines 102N of other users. In some examples, communication manager 138A may request and receive acknowledgement from client machines 102N receiving the beacon messages.

In an example, a beacon message transmitted by communication manager module 138A may include one or more products that a user has chosen to promote using a beacon device 106A. Product information provided in a beacon message may include respective product identifiers, descriptions, personal user commentary, images, third-party reviews, links, URLs, available quantities, providers 190, etc. In some examples, communication manager module 138A may transmit beacon messages based on privacy and/or profiles settings configured by a user. Thus, communication manager module 138A may construct and send beacon messages according to whether a user wishes to share certain product information with other users and/or depending on an activity, location or other attribute associated with the user. Communication manager module 138A also may send preassembled beacon messages received from client machine 102A of a user.

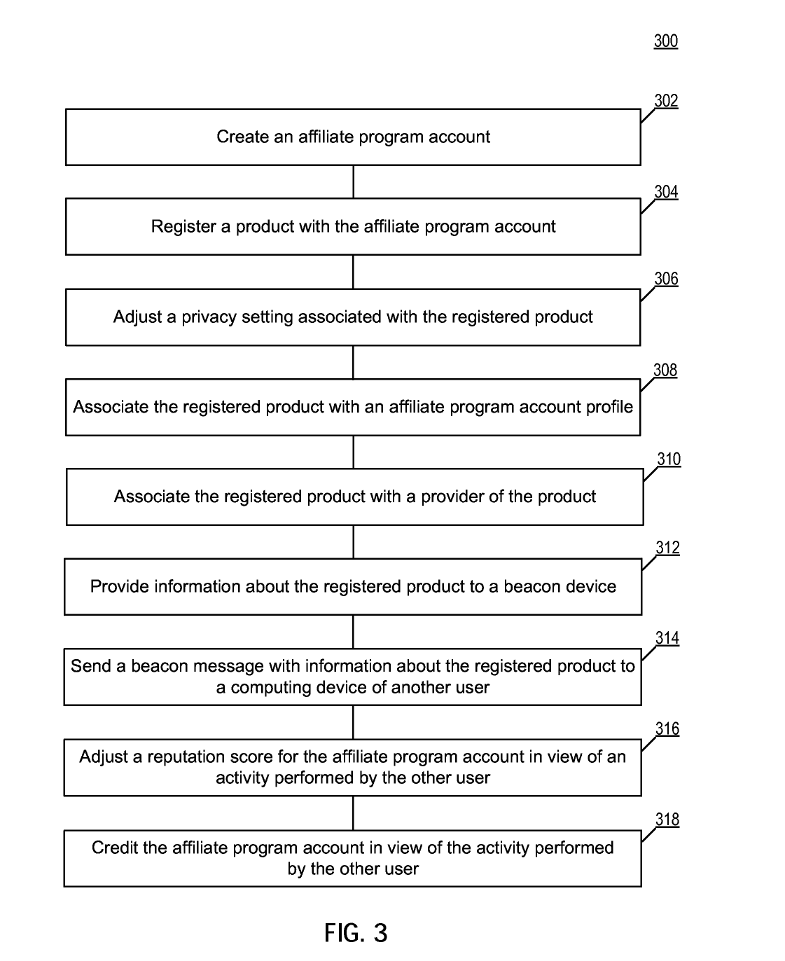

FIG. 3 is a flow diagram for providing a social commerce affiliate exchange with reputation scoring, according to an example of the present disclosure. The method 300 may be performed by processing logic that may comprise hardware (circuitry, dedicated logic, programmable logic, microcode, etc.), software (such as instructions run on a general purpose computer system, dedicated machine, or processing device), firmware, or a combination thereof. Examples in the method 300 are described with respect to social commerce affiliate system 130A for the sake of consistency. Such examples also generally apply to various other social commerce affiliate system 130, 130N examples described herein.

Method 300 begins at block 302 when account manager module 132A of social commerce affiliate system 130A creates an affiliate program account. In an example, account manager module 132A creates a user account that allows a user to participate in a social commerce affiliate exchange. Account manager module 132A may create dedicated affiliate program accounts or associate existing third-party social media and/or third-party e-mail accounts with an affiliate program.

At block 304, product manager module 134A of social commerce affiliate system 130A registers a product with the affiliate program account. In an example, product manager module 134A registers and maintains an inventory of products (i.e., goods and services) for a user account. A user then can selectively share further information about such products with other nearby users using a beacon device 106A. For example, a user may register one or more products the user owns, borrows, or otherwise utilizes with an affiliate program account.

In an example, product manager module 134A associates each product (i.e., a good or service) with the user's social commerce affiliate program account. In one example, a user registers a product to their user account by providing product manager module 134A with one or more of a unique product identifier, a descriptive product identifier, information or details about the product, a link or URL, barcodes, QR codes, photos, images, and/or other user-provided input to identify a product.

At block 306, configuration manager module 136A of social commerce affiliate system 130A adjusts a privacy setting associated with the product. In an example, a configuration manager module 136A adjusts one or more privacy settings associated with respective products in a user account. In general, privacy settings for each product may include one or more permissive and/or restrictive criteria indicating whether information about a product in a user account should be shared with others via beacon device 106A. For example, a person may wish to share information about certain product with friends or relatives, but not their boss or the public. Therefore, a user may indicate one or more other users or user groups to receive information about one or more of their products from beacon device 106A. Similarly, a user also may specify one or more other users or groups that should not receive information about specified products from beacon device 106A.

At block 308, configuration manager module 136A of social commerce affiliate system 130A associates the registered product with an affiliate program account profile. In an example, configuration manager module 136A associates a product in a user's account with one or more user account profiles. For example, a user may create one or more profiles within an affiliate program account corresponding to activities, locations, or other attributes (e.g., weather).

In an example, information about products associated with a user profile in an affiliate program account may be shared with other users via beacon device 106A when a corresponding user profile is selected or detected. For example, a user may activate one or more user profiles (e.g., at gym, outside city, etc.) to share information about associated products (e.g., running shoes, workout gear, etc.) and deactivate one or more user profiles (e.g., at work, in city) to discontinue sharing information about associated products (e.g., a suit, a briefcase, a handbag, etc.) based on a change in user status. Further, configuration manager module 136A also may automatically detect and update user profile statuses on behalf of a user automatically without user input.

At block 310, configuration manager module 136A of social commerce affiliate system 130A associates the registered product with product provider 190. In an example, configuration manager module 136A associates each of one or more products registered in a social commerce affiliate account with one or more providers 190. Such associations between products and providers allow a user promoting a product via a beacon device 106A to refer and/or direct other users to a source of the products using beacon messages. In one example, a user may flexibly associate any number of products to any number of providers. Further, when configuration manager module 136A associates a product with provider 190 a beacon message including associated product information may promote, link, or redirect other users to the associated provider 190.

At block 312, configuration manager module 136A of social commerce affiliate system 130A provides information about the registered product to beacon device 106A. In an example, a user may select one or more products in an affiliate program account to be shared with others using a beacon device 106A. In response, configuration manager module 136A may provide information about the selected product(s) to beacon device 106A for distribution to other users.

For example, a user may select one or more products in an outfit worn by the user to be provided to one or more beacon devices 106A to allow the user to share information about the products (e.g., garments worn by the user, the stylist who cut the user's hair, the user's personal trainer or gym, etc.) with others who directly or indirectly come in contact with the user. Further, other nearby users may seek to learn more about products shared by a user via a beacon message after seeing the user in person, or other users may discover the user based on beacon messages shared by the user.

In an example, a user may associate one or more products in an account with a first beacon device 106A and may associate one or more different products with another beacon device. Thus, in various examples, a user may flexibly associate any number of products with any number of beacon devices 106A. In some examples, one or more products may be associated with a beacon device 106A associated with a first provider 190 while one or more other products may be associated with a different beacon device associated with another provider 190.

At block 314, communication manager module 138A of social commerce affiliate system 130A sends a beacon message with information about the registered product to a computing device of another user. In an example, communication manager module 138A sends one or more beacon messages comprising information about products shared by a user to computing devices of other users. For example, communication manager module 138A of a client machine 102A or associated beacon device 106A may wirelessly transmit beacon messages comprising information about one or more products directly to other client machines 102N within range. Product information generally may include product identifiers, descriptions, links, URLs, provider 190 information, etc. Further product information may be distributed by communication manager module 138 based on privacy settings and/or profile settings configured by a user.

At block 316, transaction manager module 140A of social commerce affiliate system 130A adjusts a reputation score for the affiliate program account in view of an activity performed by the other user. In an example, transaction manager 140A computes a reputation score for a user account that generally indicates a user's ability to generate interest and influence the taste and decisions of others. In some examples, transaction manager 140A may determine a reputation score for a user based on a formula or generally increment and/or decrement a user's reputation score based how other users respond to and interact with beacon messages from the user.

For example, a user's reputation score generally may increase when one or more other users display, browse, or interact or interact with a beacon message from the user. A user's reputation score also may increase when one or more other users select a product from a user's beacon message for display, view a product from a user's beacon message for a period of time, save a product from a user's beacon message for later reference, add a product from a user's beacon message to a wish list, add a product from a user's beacon message to a shopping cart, purchase a product from a user's beacon message, share a product from a user's beacon message with others, or recommend a product from a user's beacon message to others. On the other hand, a user's reputation score generally may decrease based on indications that one or more other users did not notice the user's beacon messages or have chosen not to take action in response to receiving the user's beacon messages.

At block 318, transaction manager module 140A of social commerce affiliate system 130A credits the affiliate program account in view of the activity performed by the other user. In an example, transaction manager 140A credits a user's affiliate program account when another user performs an activity involving a product described in a beacon message associated with the user. For example, the user's affiliate program account may receive a referral credit for each different user that views a product, saves a product, and/or buys a product included in a beacon message from the user. In some examples, transaction manager 140A debits an account of a provider 190 receiving a product referral based on a user's beacon message. In addition, transaction manager 140 may transfer credit from a provider 190 account to a user account when a user refers others to the provider 190 via a beacon message.

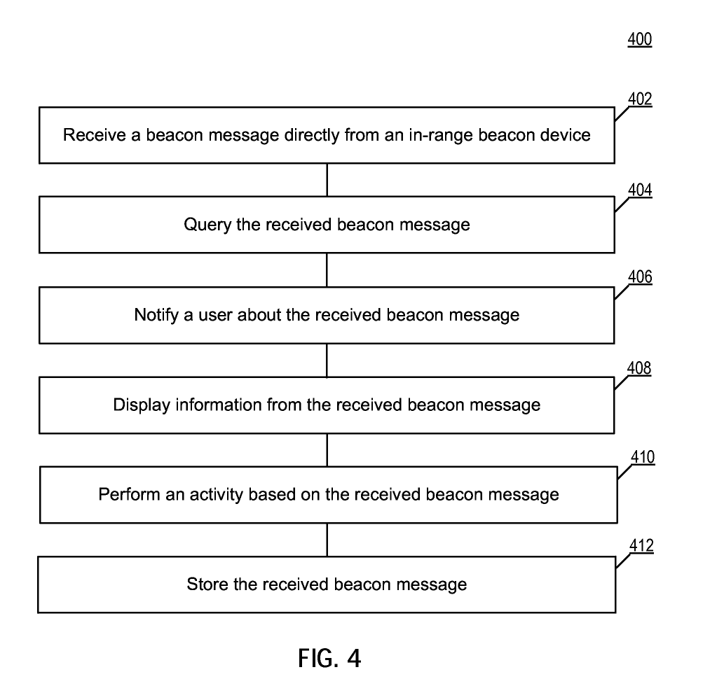

FIG. 4 is a flow diagram for processing social commerce affiliate exchange messages, according to an example of the present disclosure. The method 400 may be performed by processing logic that may comprise hardware (circuitry, dedicated logic, programmable logic, microcode, etc.), software (such as instructions run on a general purpose computer system, dedicated machine, or processing device), firmware, or a combination thereof. Examples in the method 400 are described with respect to social commerce affiliate system 130N for the sake of consistency. Such examples also generally apply to various other social commerce affiliate system 130, 130A examples described herein.

Method 400 begins at block 402 when communication manager module 138N of social commerce affiliate system 130N receives a beacon message directly from an in-range beacon device 106A. In an example, communication manager module 138N receives a beacon message comprising information about one or more products shared by another user from a beacon device 106A. Communication manager module 138N also may receive a plurality of different beacon messages from different beacon devices 106A associated with a single user or from various users.

At block 404, communication manager module 138N of social commerce affiliate system 130N queries the received beacon message. In an example, communication manager module 138N may query one or more incoming or stored beacon messages based on user-provided criteria. For example, a user may wish to search sender, product, or other information in beacon messages to filter and identify beacon messages of interest. In one example, a user creates a notification alert that queries incoming beacon messages based on one or more user-defined criteria and notifies the user when such messages are received.

At block 406, communication manager module 138N of social commerce affiliate system 130 notifies the user about the received beacon message. In an example, communication manager module 138N notifies a user when a beacon message is received. For example, communication manager module 138N may provide a user with an alert, push notification, banner notification, sound, vibration, or other indication that a beacon message has arrived. In some examples, communication manager module 138N notifies a user in response to each received beacon message. In other examples, communication manager module 138N notifies a user when an incoming beacon message matches one or more user-defined criteria indicated of a beacon message alert.

At block 408, communication manager module 138N of social commerce affiliate system 130N displays information associated with the beacon message. In an example, communication manager module 138N displays information about one or more beacon messages received by client machine 102N. For example, communication manager module 138N may display a list of beacon messages. Communication manager module 138N also may display information contained in a beacon message. Such information may include information about products shared by another user via beacon device 106A.

At block 410, transaction manager module 140N of social commerce affiliate system 130N performs an activity associated with the received beacon message. In an example, transaction manager module 140N performs an activity associated with a beacon message based on a user request. For example, transaction manager module 140N may display one or more products in a beacon message, save one or more products in a beacon message for later review, add one or more products in a beacon message to a wish list or shopping cart, initiate and complete the purchase of one or more products in a beacon message, and share or recommend one or more products in a beacon message.

At block 412, communication manager module 140N of social commerce affiliate system 130 stores the received beacon message. In an example, communication manager module 140N stores one or more beacon messages automatically or based on a user request to allow a user to reference a beacon message at another time.

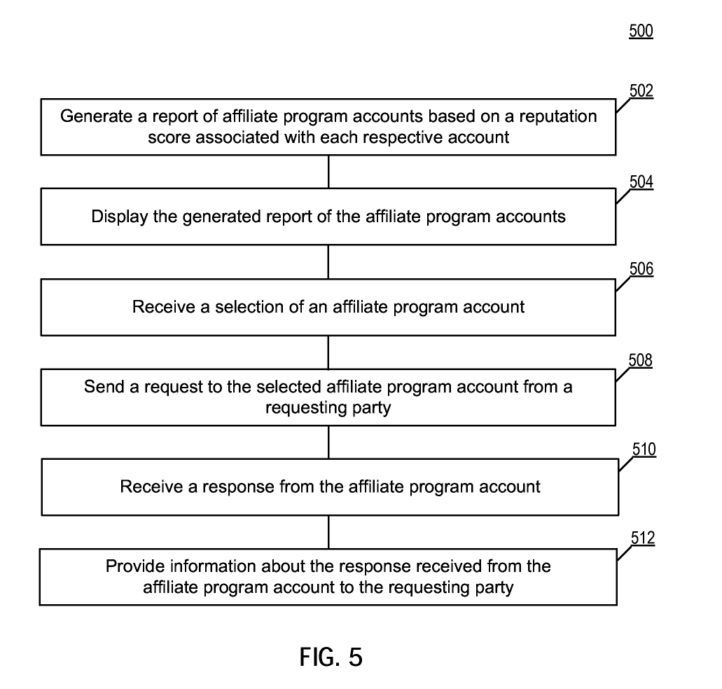

FIG. 5 is a flow diagram for providing social commerce affiliate exchange reporting, according to an example of the present disclosure. The method 500 may be performed by processing logic that may comprise hardware (circuitry, dedicated logic, programmable logic, microcode, etc.), software (such as instructions run on a general purpose computer system, dedicated machine, or processing device), firmware, or a combination thereof. Examples in the method 500 are described with respect to social commerce affiliate system 130 for the sake of consistency. Such examples also generally apply to various other social commerce affiliate system 130A, 130N examples described herein.

Method 500 begins at block 502 when report manager module 142 of social commerce affiliate system 130 generates a report of affiliate program accounts based on a reputation score associated with each respective account. In an example, report manager module 142 generates a report of affiliate program user accounts based on a reputation score computed for each account. In some examples, a generated reputation score report may indicate each user's previous success in promoting any product, promoting products in one or more product categories, promoting one or more products from provider 190, or promoting one or more specific products. In some examples, report manager module 142 also may generate reports that indicate trending users based on product referrals, users with the most beacon message views, users who have generated the most sales using beacon messages, users who have been liked the most by others users, recently added users, etc.

At block 504, report manager module 142 of social commerce affiliate system 130 displays the generated report of the affiliate program accounts. In an example, report manager module 142 displays various generated social commerce affiliate exchange reports to users and/or providers 190. In one example, report manager module 142 provides a report of affiliate program user accounts based on a reputation score to each of one or more different providers 190.

At block 506, transaction manger module 140 of social commerce affiliate system 130 receives a selection of an affiliate program account. In an example, transaction manger module 140 may receive a selection of one or more affiliate program accounts from provider 190. For example, provider 190 may select one or more affiliate program accounts from a generated report or other graphical user interface.

At block 508, communication manager module 138 of social commerce affiliate system 130 sends a request to a selected affiliate program account. In an example, communication manager module 138 sends a request from provider 190 to a selected affiliate program account offering to compensate the affiliate program account for referrals, product sales, etc. For example, provider 190 may offer an affiliate program account user a commission for referring other users to the provider 190 and generating sales for the provider using beacon devices 106A.

At block 510, communication manager module 138 of social commerce affiliate system 130 receives a response from the affiliate program account. In an example, communication manager module 138 receives a response to a provider 190 offer from an affiliate program account user. For example, an affiliate program account user may accept, reject, or provide a counter offer in response to a provider 190 offer.

At block 512, communication manager module 138 of social commerce affiliate system 130 provides information about the response received from the affiliate program account to the requesting party. In an example, communication manager module 138 provides a provider 190 with an affiliate program account user's response to the provider's offer 190. In examples where an affiliate program account user and provider 190 reach an agreement, transaction manager 140 uses the agreed upon terms to manage transactions involving the affiliate program user's promotion of the provider 190 and associated products via beacon devices 106A.

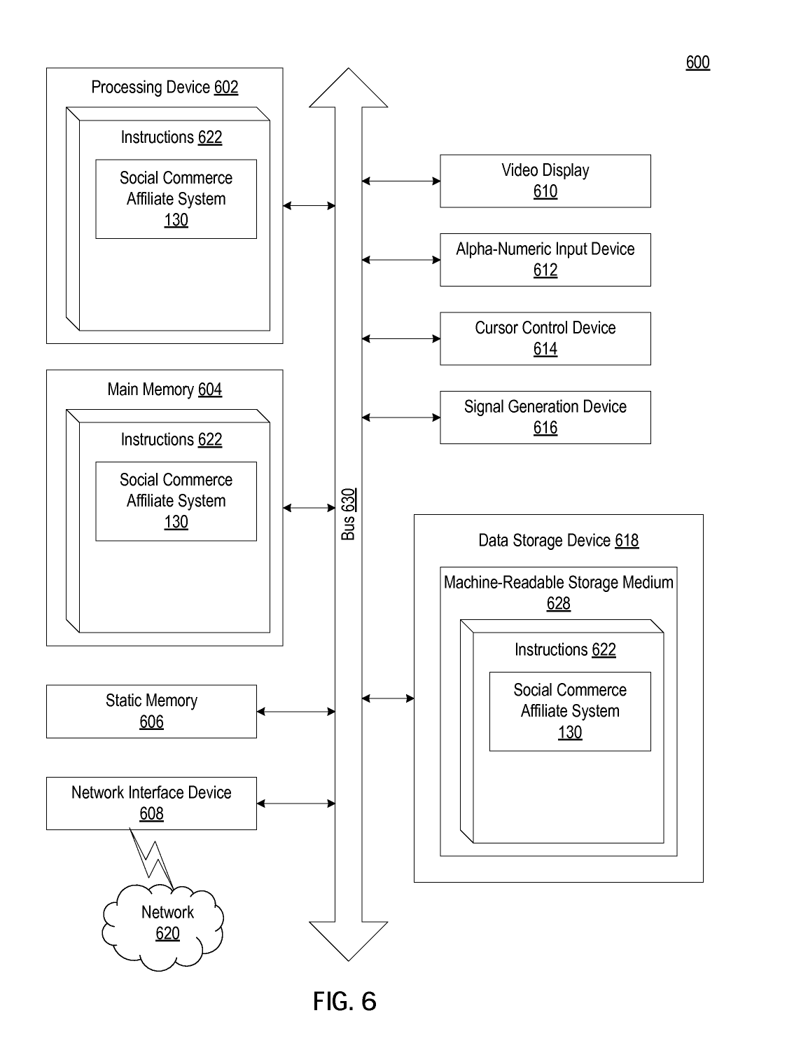

FIG. 6 illustrates a diagram of a machine in the exemplary form of a computer system 600, within which a set of instructions for causing the machine to perform any one or more of the methodologies discussed herein may be executed. In other examples, the machine may be connected (e.g., networked) to other machines in a LAN, an intranet, an extranet, or the Internet. The machine may operate in the capacity of a server or a client machine in client-server network environment, or as a peer machine in a peer-to-peer (or distributed) network environment. The machine may be a personal computer (PC), a tablet PC, a set-top box (STB), a Personal Digital Assistant (PDA), a cellular telephone, a wearable computing device, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 600 includes a processing device (processor) 602, a main memory 604 (e.g., read-only memory (ROM), flash memory, dynamic random access memory (DRAM) such as synchronous DRAM (SDRAM), double data rate (DDR SDRAM), or DRAM (RDRAM), etc.), a static memory 606 (e.g., flash memory, static random access memory (SRAM), etc.), and a data storage device 618, which communicate with each other via a bus 630.

Processor 602 represents one or more general-purpose processing devices such as a microprocessor, central processing unit, or the like. More particularly, the processor 602 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 602 also may be one or more special-purpose processing devices such as an application specific integrated circuit (ASIC), a field programmable gate array (FPGA), a digital signal processor (DSP), network processor, or the like. The processor 602 is configured to execute instructions 622 for performing the operations and steps discussed herein.

The computer system 600 also may include a network interface device 608. The computer system 600 may further include a video display unit 610 (e.g., a liquid crystal display (LCD) or a cathode ray tube (CRT)), an alphanumeric input device 612 (e.g., a keyboard), a cursor control device 614 (e.g., a mouse), and a signal generation device 616 (e.g., a speaker).

The data storage device 618 may include a computer-readable storage medium 628 on which is stored one or more sets of instructions 622 (e.g., software computer instructions) embodying any one or more of the methodologies or functions described herein. The instructions 622 also may reside, completely or at least partially, within the main memory 604 and/or within the processor 602 during execution thereof by the computer system 600, the main memory 604 and the processor 602 also constituting computer-readable storage media. The instructions 622 may be transmitted or received over a network 620 via the network interface device 608.

In one example, the instructions 622 include instructions for one or more modules of a social commerce affiliate system (e.g., social commerce affiliate system 130 of FIG. 1) and/or a software library containing methods that call a social commerce affiliate system. While the computer-readable storage medium 628 (machine-readable storage medium) is shown as an example to be a single medium, the term “computer-readable storage medium” should be taken to include a single medium or multiple media (e.g., a centralized or distributed database, and/or associated caches and servers) that store the one or more sets of instructions. The term “computer-readable storage medium” also may include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

Numerous details are set forth in the foregoing description. However, it will be apparent to one of ordinary skill in the art having the benefit of this disclosure that the present disclosure may be practiced without these specific details. In some instances, well-known structures and devices are shown in block diagram form, rather than in detail, to avoid obscuring the present disclosure.

Some portions of the detailed description have been presented in terms of algorithms and symbolic representations of operations on data bits within a computer memory. Here, an algorithm is generally conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “computing”, “comparing”, “associating”, “applying”, “transmitting”, “receiving,” “processing,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Certain examples of the present disclosure also relate to an apparatus for performing the operations herein. This apparatus may be constructed for the intended purposes, or it may comprise a general-purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

It is to be understood that the above description is intended to be illustrative, and not restrictive. Many other examples will be apparent to those of skill in the art upon reading and understanding the above description. The scope of the disclosure therefore should be determined with reference to the appended claims, along with the full scope of equivalents to which such claims are entitled.

What is claimed is:

1. A computer system, comprising:
a memory;
a processing device coupled to the memory;
a product manager, executed by the processing device, to register a product with an affiliate program account of a user;
a configuration manager, executed by the processing device, to provide information about the registered product to a beacon device; and
a communication manager, executed by the processing device, to send a beacon message comprising the information about the registered product to a computing device of a second user.

2. The computer system of claim 1, further comprising:
an account manager, executed by the processing device, to create the affiliate program account for the user.

3. The computer system of claim 1, wherein the configuration manager further:
adjusts a privacy setting associated with the registered product in the affiliate program account.

4. The computer system of claim 1, wherein the configuration manager further:
associates the registered product with a profile in the affiliate program account.

5. The computer system of claim 1, wherein the configuration manager further:
associates the registered product with a provider of the product.

6. The computer system of claim 1, further comprising:
a transaction manager, executed by the processing device, to detect an activity performed by the second user involving the beacon message.

7. The computer system of claim 1, further comprising:
a transaction manager, executed by the processing device, to adjust a reputation score for the user in view of an activity associated with the beacon message performed by the second user.

8. The computer system of claim 1, further comprising:
a transaction manager, executed by the processing device, to credit the affiliate program account of the user in view of an activity associated with the beacon message performed by the second user.

9. The computer system of claim 1, wherein the configuration manager further:
associates a second product registered with the affiliate program account of the user with a second provider.

10. The computer system of claim 1, wherein the configuration manager further:
provides information about a second product registered with the affiliate program account of the user to the beacon device.

11. The computer system of claim 10, wherein the beacon message sent by the communication manager further comprises the information about the second registered product.

12. The computer system of claim 1, wherein the configuration manager further:
associates a second product registered with the affiliate program account of the user with a second beacon device.

13. The computer system of claim 1, further comprising:
a second beacon device to send a second beacon message comprising information about a second product registered with the affiliate program account of the user to the computing device of the second user.

14. The computer system of claim 1, further comprising:
a reporting manager, executed by the processing device, to generate a report of affiliate program users based on a reputation score computed for each of the users.

15. The computer system of claim 1, wherein the communication manager sends the beacon message directly to the computing device of the second user when the computing device of the second user is in range of the beacon device.

16. The computer system of claim 1, wherein the beacon device is integrated in clothing.

17. The computer system of claim 1, wherein the beacon device is integrated with a vehicle.

18. The computer system of claim 1, wherein the memory, the processing device, and the beacon device are comprised as part of a single computing device.

19. A computer-implemented, comprising:
associating a product with an affiliate program account of a user;
providing information about the associated product to a beacon device; and
sending a beacon signal comprising the information about the registered product to a computing device of a second user.

20. A non-transitory computer-readable medium comprising computer-readable instructions that, when executed by one or more processors of a computer system, cause the one or more processors to perform operations comprising:
registering a product with an affiliate program account of a user;
storing information about the registered product; and
sending, using a beacon device, a message comprising the information about the registered product to a computing device of a second user in range of the beacon device.
